(19) United States
(12) Patent Application Publication
(10) Pub. No.: US 2002/0191718 A1
(43) Pub. Date: Dec. 19, 2002

(54) Method and apparatus for automatically compensating for attenuation in a received signal

(76) Inventor: Michael Glynn Ellis SR., Alpharetta, GA (US)

Correspondence Address: NEEDLE & ROSENBERG, P.C., The Candler Building, 127 Peachtree Street, N.E, Atlanta, GA, 30303-1811, US

(21) Appl. No.: 10/172,042

(22) Filed: Jun. 13, 2002

Related U.S. Application Data
(60) Provisional application No. 60/297,879, filed on Jun. 13, 2001.

(51) Int. Cl. H04L 27/08; H04L 25/00; H04B 3/00

(52) U.S. Cl. 375/345; 375/257

(57) ABSTRACT

Attenuation in a received signal caused during transmission of the signal to a receiver is automatically compensated. An amplitude of first reference data within the received signal is compared with an amplitude of second reference data. A gain of the received signal is varied based on the results of the comparison. The amplitude comparison and gain varying are repeated until the amplitude of the first reference data and the amplitude of the second reference data differ by a predetermined amount.

### BACKGROUND

The present invention is directed to a method and apparatus for compensating for attenuation. More particularly, the present invention is directed to a method and apparatus for automatically compensating for attenuation in a received signal caused by transmission of the signal.

Signals transmitted from a transmitter to a receiver often suffer attenuation due, e.g., to the transmission medium. For example, analog signals transmitted over a twisted pair cable often suffer attenuation due to the cable. This attenuation may be understood with reference to FIG. 1.

FIG. 1 shows an analog video baseband red, green, blue (RGB) signal transmitted across three pairs of a category-5 cable 100. The cable 100 acts as a low pass filter, causing attenuation of the signal at high frequencies as it is transmitted to the receiver. The frequency response of the received signal rolls off at the higher frequencies, as shown in FIG. 1. The longer the cable, the more severe the attenuation.

The more that is known about the cause of the attenuation, the easier it is to compensate for the attenuation. For example, since the attenuation caused by a cable depends largely on the length of the cable, if the cable length is known, it is easy to determine the appropriate compensation to apply at the receiver end.

Often, not much is known about the transmission medium. For example, the length of a cable across which an analog signal is transmitted may not be known. This poses a problem for compensating for attenuation caused by the medium. Typically, the signal is not properly compensated or compensation is provided by a cumbersome trial and error approach.

It is therefore an object of the present invention to provide a technique for automatically compensating for attenuation in a received signal in an easy and accurate manner.

### SUMMARY

It is an object of the present invention to provide a technique for easily and properly compensating for attenuation in a received signal.

According to exemplary embodiments, this and other objects are met by a method and apparatus for compensating for attenuation of a received signal transmitted from a transmitter. An amplitude of first reference data within the received signal is compared with an amplitude of second reference data. A gain of the received signal is varied based on results of the comparison. The amplitude comparison and the gain varying are repeated until the amplitude of the first reference data within the received signal and the amplitude of the second reference data differ by a predetermined amount.

According to one embodiment, the first reference data is transmitted at a first frequency within the signal, and the second reference data is transmitted at a second frequency within the signal. The data transmitted at the first frequency and the data transmitted at the second frequency may be inserted into the transmitted signal or may be inherent in the transmitted signal.

According to another embodiment, the second reference data is locally generated at the receiver end. The second reference data has known characteristics that are common with characteristics of the first reference data, and the amplitude of the second reference data is compared with the amplitude of the first reference data within the received signal at the receiver end.

Further objects, advantages and features of the present invention will become more apparent when reference is made to the following description taken in conjunction with the accompanying drawings.

### BRIEF DESCRIPTION OF THE DRAWINGS

FIG. 1 illustrates a conventional arrangement with analog video signals driving a twisted pair cable;

FIG. 2 illustrates an exemplary apparatus for compensating for attenuation in a received signal according to an exemplary embodiment; and

FIG. 3 illustrates an exemplary method for compensating for attenuation in a received signal according to an exemplary embodiment.

### DETAILED DESCRIPTION

According to exemplary embodiments, an automatic compensation method and apparatus compensate for attenuation in a received signal caused during transmission of the signal.

According to one embodiment, a method and apparatus correct for high frequency loss in a transmission medium, such as a twisted pair cable, caused as analog information is transmitted over the cable. Pulses inherent in the analog signal or pulses inserted into the analog signal may be used to adjust the compensation of the received signal to suit the length of the cable. Also, a reference signal may be compared with a pulse within the transmitted signal at the receiver end to adjust the compensation.

For illustrative purposes, the example described below is directed to a high resolution baseband RGB video signal transmitted over hundreds of feet of twisted pair cable. It will be appreciated that the invention is not limited to the details of this example.

The bandwidth of a high resolution RGB signal may approach 150 MHz. The attenuation of such a signal transmitted across a twisted pair cable is greater at the higher frequencies.

According to an exemplary embodiment, this attenuation is compensated for by using a comparison of amplitudes of reference data, such as pulses within the transmitted analog signal, to adjust a frequency compensation network at the receiver side of the cable. These pulses may occur naturally as part of the analog signal or may be artificially inserted into the analog signal.

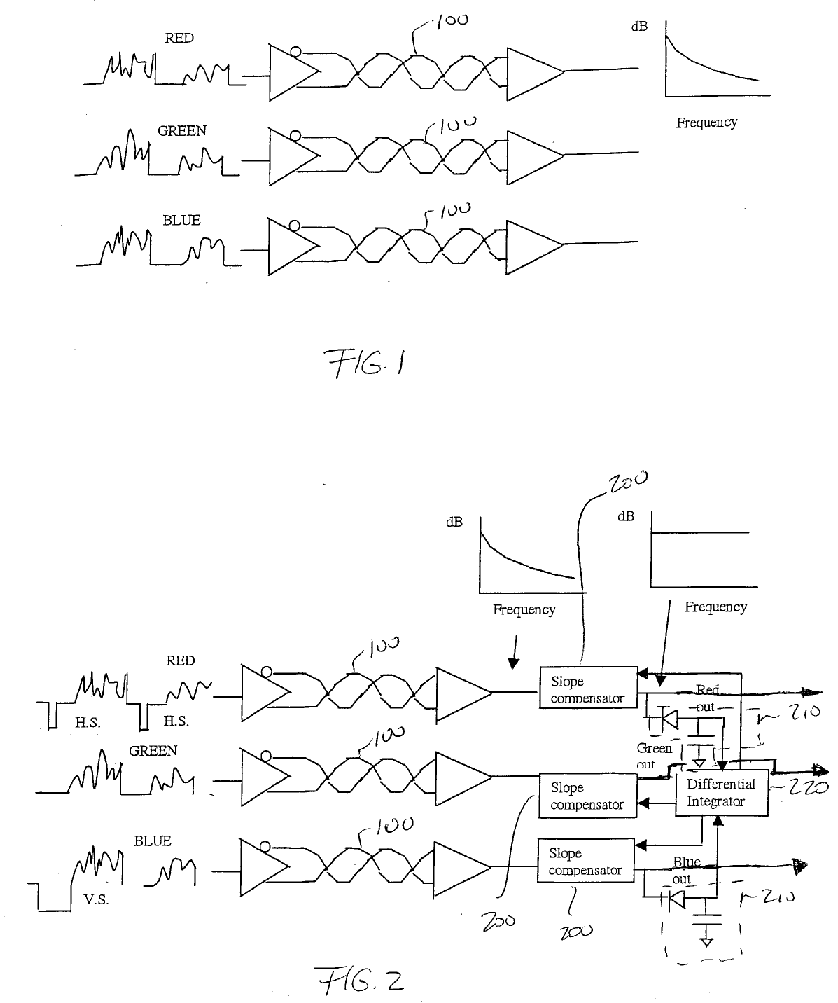

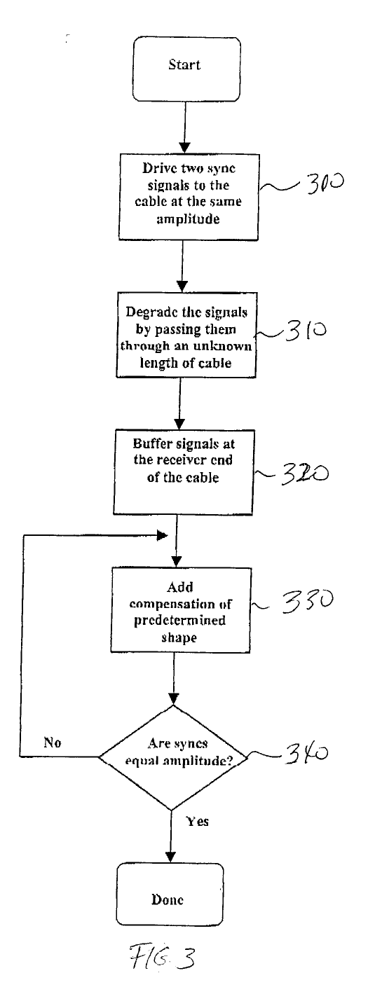

For example, FIG. 2 shows a RGB analog video signal transmitted across a cable 100 with a horizontal synchronization (sync) signal inserted on the RED component and a vertical synchronization (sync) signal inserted on the BLUE component. Both sync signals are inserted as negative pulses relative to the video signal, in this example.

The horizontal sync pulse is much shorter than the vertical sync pulse and is transmitted at a higher frequency than the vertical sync signal. Since attenuation occurs at high frequencies, the horizontal sync is attenuated in amplitude by the limited frequency response of the cable. The vertical sync pulse, being much longer, is effectively not attenuated by the cable. The long interval of the vertical sync approximates a DC signal for its duration. Although these sync signals may be applied at the same amplitude at the transmitter end, because of high frequency roll-off in the cable, the horizontal sync is of lower amplitude at the receiver end.

The received video signal components may be buffered at the receiver end (and/or at the transmitter end). Also, a predetermined compensation may be applied to the components of the transmitted signal at the receiver end, e.g., in a slope compensator 200.

The amplitudes of the received vertical sync signal and horizontal sync signal are detected at the receiver end, e.g., by DC level detection circuits 210. These level detection circuits may be implemented, with diodes and voltage supplies in a manner understood to those skilled in the art.

A comparison circuit 220 compares the difference between the detected amplitude levels. Based on the comparison results, the compensation of the received signal is adjusted until the detected amplitude levels differ by a predetermined amount. For example, if the vertical sync signal and the horizontal sync signal are transmitted at the same amplitude, the compensation of the received signal is adjusted until the difference between the amplitude levels is determined by the comparison circuit to be zero.

In the example shown in FIG. 2, a DC signal is applied by the comparison circuit 220 to a compensation network until the overall frequency response is flat. The comparison circuit 220 may be implemented with, e.g., a differential integrator. The compensation network may be implemented with slope compensator 200 that applies compensation to the separate components of the video signal, based on the comparison results.

The amplitudes of the signals output from the slope compensators 200 are detected again and compared in the comparison circuit 220, and the compensation is adjusted until the amplitude of the horizontal sync pulse and the vertical sync pulse are, for example, the same at the receiver end. At this point, the frequency response of the horizontal sync signal is flat, and compensation is complete. Then, the components of the RGB signal may be output and further processed at the receiver end, e.g., for display, etc.

FIG. 3 illustrates an exemplary method for automatically compensating for attenuation in transmitted signals. The method illustrated in FIG. 3 is directed to compensation for attenuation in a transmitted analog video signal, using a comparison of transmitted horizontal and vertical sync signals. It will be appreciated that this illustration is provided as an example to aid in understanding of the invention, but that the invention is not limited to this particular embodiment.

Referring to FIG. 3, a compensation method begins at step 300 at which two transmitted pulses of different lengths, such as a vertical sync signal and a horizontal sync signal, are driven through the cable at the same amplitude. The signals are degraded by passing them through an unknown length of cable at step 310. At step 320, on the receiver end, the signals are, for example, buffered. At step 330, compensation of a predetermined shape, suited for the cable, is provided. The gain of the received signal is adjusted via a compensation network until it is determined, at step 340, that the amplitudes of compensated sync signals differ by a predetermined amount, e.g., zero. Since the gain required for compensation is a function of the length of the cable, if the compensated sync signals are of equal amplitude, then the appropriate compensation for the cable length has been provided, and the process stops. If not, the process returns to step 330.

Although in the example above, the horizontal and vertical sync signals are used for compensation, it will be appreciated that any combination of pulses of different lengths, e.g., low frequency long pulses and high frequency short pulses, may be used for compensation.

Also, rather than using two pulses of different frequencies for comparison as described above, other types of reference signals and comparison techniques may be used. For example, pilot tones, tone bursts, or any other types of signals having different frequencies may be inserted within the analog signal, transmitted, and compared.

Further, although the horizontal and vertical signal sync discussed above are transmitted at the same amplitude, reference signals having different amplitudes may be used. At the receiver end, the received signal may be adjusted so that the amplitudes of the reference data have the same relationship as the amplitudes of the reference signals upon transmission.

As another example, a single frequency signal having known characteristics may be inserted within the analog signal, transmitted, and compared at the receiver end with a locally generated reference signal having the same known characteristics as the single frequency signal. In this case, compensation is applied to the received signal until the amplitude of the received single frequency signal differs from the amplitude of the reference signal by a predetermined amount.

It should be understood that the foregoing description and accompanying drawings are by example only. A variety of modifications are envisioned that do not depart from the scope and spirit of the invention. The above description is intended by way of example only and is not intended to limit the present invention in any way.

What is claimed is:

1. A method for automatically compensating for attenuation in a received signal caused during transmission of the signal to a receiver, the method comprising the steps of:
comparing an amplitude of first reference data within the received signal with an amplitude of second reference data;
varying a gain of the received signal based on results of the comparing step; and
repeating the steps of comparing the amplitudes and varying the gain until the amplitude of the first reference data within the received signal and the amplitude of the second reference data differ by a predetermined amount.

2. The method of claim 1, wherein the first reference data is transmitted within the signal to the receiver at a first frequency.

3. The method of claim 2, wherein the predetermined amount corresponds to a difference between an amplitude of the first reference data upon transmission within the signal and the amplitude of the second reference data.

4. The method of claim 3, wherein the amplitude of the first reference data upon transmission within the signal is the same as the amplitude of the second reference data.

5. The method of claim 4, wherein the steps of comparing the amplitudes and varying the gain are repeated until the amplitude of the first reference data within the received signal and the amplitude of the second reference data differ by zero.

6. The method of claim 2, wherein the second reference data is transmitted within the signal to the receiver at a second frequency.

7. The method of claim 6, wherein the first reference data and the second reference data are inserted into the signal transmitted to the receiver.

8. The method of claim 6, wherein the first reference data and the second reference data are inherent in the signal transmitted to the receiver.

9. The method of claim 2, wherein the second reference data is locally generated at the receiver and includes known characteristics that are common with characteristics of the first reference data.

10. The method of claim 6, wherein the first frequency is lower than the second frequency.

11. The method of claim 6, wherein the first reference data and the second reference data include pilot tones, tone bursts, or any other types of signals having different frequencies.

12. The method of claim 1, wherein the steps are performed in the receiver.

13. The method of claim 1, wherein the signal is transmitted as an analog signal across a cable having a fixed length.

14. The method of claim 13, wherein the steps are applied until a compensation suitable for the length of the cable is determined.

15. The method of claim 13, wherein the fixed length of the cable is unknown.

16. The method of claim 1, wherein the transmitted signal includes a video signal.

17. The method of claim 1, wherein the first reference data includes a vertical synchronization signal, and the second reference data includes a horizontal synchronization signal.

18. The method of claim 16, wherein the video signal includes color components transmitted over separate wires within a cable.

19. The method of claim 18, wherein the first reference data is transmitted at a first frequency within one color component of the video signal, and the second reference data is transmitted at a second frequency within another color component of the video signal.

20. The method of claim 1, wherein the steps are performed for compensating for high frequency loss in the transmitted signal.

21. The method of claim 1, wherein the attenuation is caused by a medium in which the signal is transmitted.

22. The method of claim 21, wherein the medium causing the attenuation has at least one unknown characteristic that contributes to the attenuation.

23. An apparatus for compensating for attenuation in a received signal caused during transmission of the signal to a receiver, comprising:
comparing means for comparing an amplitude of first reference data within the received signal with an amplitude of second reference data; and
gain control means for varying the gain of the received signal based on the results of the comparison, wherein the comparing means compares the amplitudes and the gain control means varies the gain until the amplitude of the first reference data within the received signal differs from the amplitude of the second reference data by a predetermined amount.

24. The apparatus of claim 23, wherein the first reference data is transmitted at a first frequency within the signal.

25. The apparatus of claim 24, wherein the predetermined amount corresponds to a difference between the amplitude of the first reference data upon transmission within the signal and the amplitude of the second reference data.

26. The apparatus of claim 25, wherein the amplitude of the first reference data upon transmission within the signal is the same as the amplitude of the second reference data.

27. The apparatus of claim 26, wherein the comparing means compares the amplitudes and the gain control means varies the gain until the amplitude of the first reference data within the received signal differs from the amplitude of the second reference data by zero.

28. The apparatus of claim 24, wherein the second reference data is transmitted at a second frequency within the signal.

29. The apparatus of claim 28, wherein the first reference data and the second reference data are inserted into the signal transmitted to the receiver.

30. The apparatus of claim 28, wherein the first reference data and the second reference data are inherent in the signal transmitted to the receiver.

31. The apparatus of claim 24, wherein the second reference data is locally generated at the receiver and includes known characteristics that are common with characteristics of the first reference data.

32. The apparatus of claim 28, wherein the first frequency is lower than the second frequency.

33. The apparatus of claim 28, wherein the first reference data and the second reference data include pilot tones, tone bursts, or any other types of signals having different frequencies.

34. The apparatus of claim 23, wherein the comparing means and gain control means are included in the receiver.

35. The apparatus of claim 23, wherein the transmitted signal is transmitted as an analog signal across a cable having a fixed length.

36. The apparatus of claim 35, wherein the comparing means performs comparison and the gain control means varies the gain of the received signal until a compensation suitable for the length of the cable is determined.

37. The apparatus of claim 35, wherein the fixed length of the cable is unknown.

38. The apparatus of claim 23, wherein the transmitted signal includes a video signal.

39. The apparatus of claim 23, wherein the first reference data includes a vertical synchronization signal, and the second reference data includes a horizontal synchronization signal.

40. The apparatus of claim 38, wherein the video signal includes color components transmitted over separate wires within a cable.

41. The apparatus of claim 40, wherein the first reference data is transmitted at a first frequency within one color component of the video signal, and the second reference data is transmitted at a second frequency within another color component of the video signal.

42. The apparatus of claim 23, wherein the compensation is performed for high frequency loss in the received signal.

43. The apparatus of claim 23, wherein the attenuation is caused by a medium in which the signal is transmitted.

44. The apparatus of claim 43, wherein the medium causing the attenuation has at least one unknown characteristic that contributes to the attenuation.
